(19) United States
(12) Patent Application Publication
(10) Pub. No.: US 2007/0045880 A1
(43) Pub. Date: Mar. 1, 2007

(54) Integration of evaporative cooling within microfluidic systems

(75) Inventors: Aditya Rajagopal, Pasadena, CA (US); Axel Scherer, Laguna Beach, CA (US); George Maltezos, Fort Salonga, NY (US)

Correspondence Address: Alessandro Steinfl, Esq.;c/o LADAS & PARRY, Suite 2100, 5670 Wilshire Boulevard, Los Angeles, CA, 90036-5679, US

(73) Assignee: CALIFORNIA INSTITUTE OF TECHNOLOGY

(21) Appl. No.: 11/512,053

(22) Filed: Aug. 28, 2006

Related U.S. Application Data
(60) Provisional application No. 60/712,746, filed on Aug. 30, 2005.
(60) Provisional application No. 60/787,729, filed on Mar. 30, 2006.

(51) Int. Cl. B01F 3/04; F28D 5/00; F25B 37/00

(52) U.S. Cl. 261/140.1; 62/304; 261/128

(57) ABSTRACT

Evaporative cooling is an effective and efficient method for rapidly removing heat from a system device. In accordance with the disclosure herein, a microfluidic Y-junction apparatus is provided which can produce low temperatures and can be integrated into microdevices.

### CROSS REFERENCE TO RELATED APPLICATIONS

This application claims priority to U.S. Provisional Ser. No. 60/712,746 for “Integration of Evaporative Cooling Within Microfluidic Systems” filed on Aug. 30, 2005, which is incorporated herein by reference in its entirety. This application also claims priority to U.S. Provisional Ser. No. 60/787,729 for “Integration of Evaporative Cooling Within Microfluidic Systems” filed on Mar. 30, 2006, which is incorporated herein by reference in its entirety.

### STATEMENT OF GOVERNMENT SUPPORT

The invention described herein was made in the performance of work under a grant from the National Institute of Health (NIH), Grant No. R01 HG002644.

### BACKGROUND

1. Field

The present disclosure relates to the integration of evaporative cooling within microfluidic channels to effectively and efficiently remove heat from a system.

2. Description of Related Art

Miniaturization of components has been steadily increasing in the fields of electronics and optics. This rapid increase in transistor density creates increased heat and a need for heat dissipation in order to maintain levels of processing power and device speed. Heat dissipation has been addressed in a variety of ways, from ‘sleep transistors’ to on-chip micro-refrigeration (Shakouri, A. and Zhang, Y. IEEE Transactions on Components and Packaging Technologies, 28, (1), 2005). In addition to electronic applications of heat dissipation (refrigeration), there are several other applications for miniaturized refrigerators, including optical and microwave detector cooling, polymerase chain reactor cycling and thermal stabilization of high power telecommunication lasers. Temperature control has also become an integrated part of microfabricated chemical “laboratories” wherein sub-nanoliter volumes of reagents are reacted on microfluidic chips.

Local refrigeration to cool a device which is a part of or proximal to that device is difficult. Traditionally, the semiconductor industry has developed thermoelectric coolers which rely on a heat-sink and semiconductor junctions to provide an electrically induced temperature gradient. A heat sink at the micro levels can result in a larger overall structure.

Thus, what is needed to address this increasing need for heat dissipation of microdevices is an efficient and effective micro-means to provide temperature control.

### SUMMARY

A new method and apparatus are provided herein for providing termperature control with localized cooling through evaporation of volatile materials within microfluidic channels.

According to a first aspect of the present disclosure, an apparatus is provided for evaporative cooling of microfluidic devices comprising a Y-junction comprising a first input channel, a second input channel, a junction region and an output channel, wherein refrigerant is fed through the first input channel and gas is fed through the second input channel; said refrigerant and gas mixing at said junction region.

According to a second aspect of the present disclosure, a method for fabricating an apparatus for evaporative cooling is provided, comprising: forming a mold of a Y junction comprising a first and a second input channel, a junction region and an output channel; chemically curing the wax mold; thermally curing the wax mold; preparing polydimethylsiloxane; applying the polydimethylsiloxane to the wax mold to form a polydimethylsiloxane block; cropping the polydimethylsiloxane block; de-waxing the polydimethylsiloxane block by heat; rinsing the plydimethylsiloxane blocks to remove residual wax; providing refrigerant to the first input channel, and providing gas to the second input channel.

According to a third aspect of the present disclosure, a method for providing localized evaporative cooling to a system is provided, comprising: attaching a Y-junction device to said system wherein the Y-junction device comprises a first and a second input channel, a junction region and an output channel; feeding refrigerant through the first input channel; feeding gas through the second input channel, whereby the refrigerant and gas mix at the junction.

### BRIEF DESCRIPTION OF THE DRAWINGS

FIG. 1 shows a diagram of a Y-junction with a refrigerant input channel arm (10), a gas input channel arm (20), a junction region (30) and an outlet channel (40), and an optional selective membrane (50).

FIG. 2 shows a graph of temperature drop versus time using four refrigerants.

FIG. 3 shows a graph of the minimal attainable temperature as a function of pressure with respect to time.

FIG. 4 shows a graph of the minimal attainable temperature as a function of Y-junction arm angle with respect to time.

FIG. 5 shows a graph of the minimal attainable temperature as a function of Y-junction arm angle.

### DETAILED DESCRIPTION

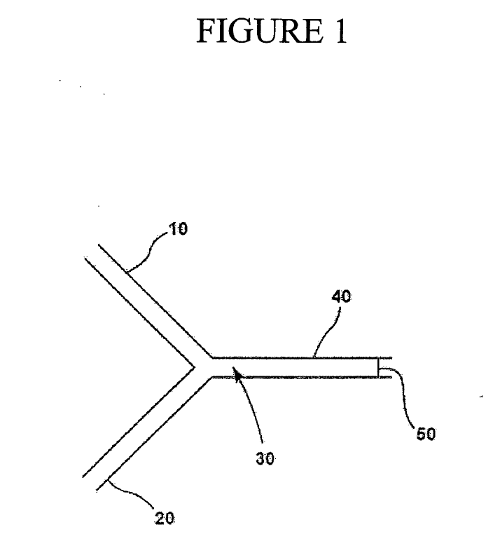

Refrigeration can be achieved through the endothermic mixing of compressed gases with an evaporating liquid. The present disclosure provides for a new device fabricated to carry out the mixing of gas and an evaporative liquid comprising a Y-junction with two-input channels (FIG. 1). The refrigerant (e.g. di-ethyl ether, acetone, isopropanol, ethanol) is provide through one input channel arm (10), and a gas (e.g. N₂) is provided through the second input channel arm (20). These two mix in at the junction region of the Y (30) and then continue through to the output channel (40) at the stem of the Y configuration. Variation of refrigerant, angle between the two channel arms and pressure of gas each influence the rate of cooling.

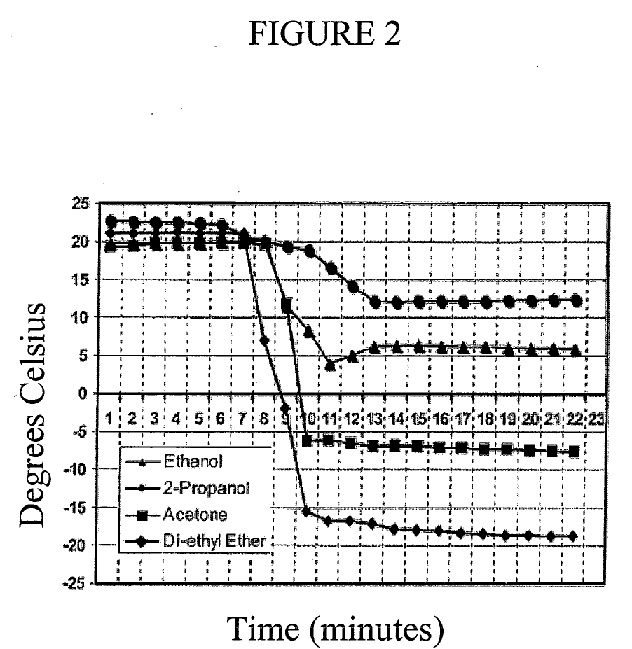

FIG. 2 shows that of diethylether was the optimal refrigerant under the given conditions in comparison to isopropanol, acetone and ethanol. One of skill in the art can optimize other refrigerants as well as use isopropanol, acetone and ethanol depending on the cooling required for a given system. Under the given conditions in FIG. 2, diethyl ether provided the lowest temperature and the fastest cooling rate.

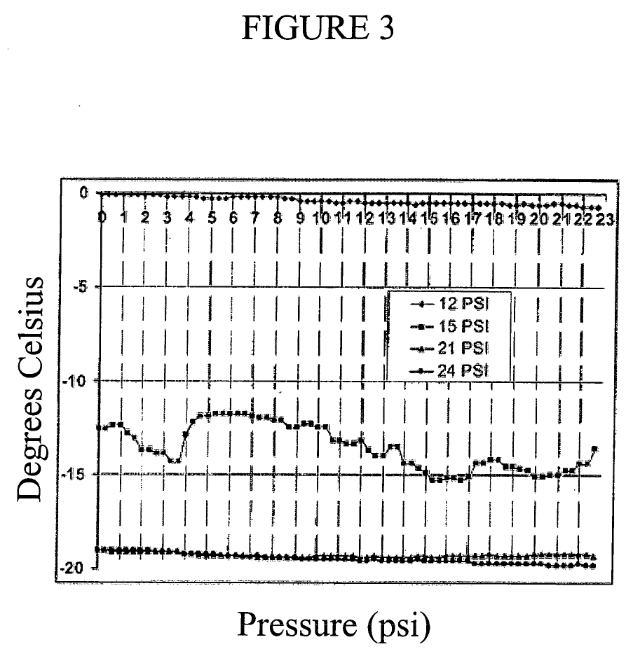

FIG. 3 shows that nitrogen gas applied at a pressure of 21 pounds per square inch (psi) provided the lowest temperature. Higher pressures (up to 36 psi) did not achieve lower temperatures with a 10 degree angle between the two channel arms.

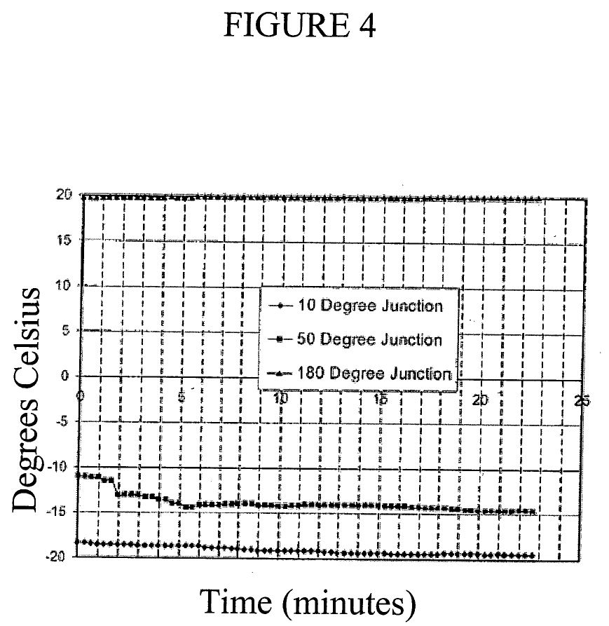

FIG. 4 shows that a 10 degree angle between the two channel arms provides the lowest temperature compared with 50 and 100 degrees.

In a preferred embodiment of the present disclosure, an apparatus for evaporative cooling comprises a Y-junction wherein the Y-junction comprises two arms and a junction, wherein one arm forms a first channel for a refrigerant and the second arm forms a second channel for the gas, and the refrigerant and gas mix at the junction of the two arms in the outlet channel (see FIG. 1).

In one embodiment the Y-junction is made of polydimethylsiloxane using wax molds. For use with microfluidic devices, the Y-junction can be made with channels of 6.5 mm in length and a diameter of 0.650 mm. The length and diameter of the channels can be optimized by one of skill in the art depending on the cooling application.

In one embodiment a thermocoupler is inserted into the refrigerant channel of the Y-junction in order to measure the temperature. A thermometer can be attached to the thermocoupler to facilitate temperature measurement.

In a further embodiment, a selective membrane (50) is incorporated into the apparatus and inserted into the outlet channel such that the gas provided to the gas channel is allowed to pass through, but the liquid refrigerant is retained, thus allowing for recycling and reuse of the refrigerant. The selection of membrane is specific to the choice of refrigerant. For example, if water is used as the refrigerant, the commercial polymer Nafion (DuPont Corp.) can be used to recover water. In another embodiment, a thin membrane of PDMS can serve as the selective membrane, as this elastomer is permeable to gas but not to water.

### EXAMPLE 1

### Fabrication of the Wax Molds and PDMS Y-Junction

In a preferred embodiment of the present disclosure, a method for fabricating an apparatus for evaporative cooling is provided comprising the steps of first forming molds using a wax printer. To obtain the wax design, a three-dimensional modeling tool was used (SolidWorks) and then converted to a usable file format using SolidScape's ModelWorks software. The wax molds of the fluidic channels were created using a SolidScape T66 wax printer. The wax molds were then chemically cured (to remove unwanted wax) with Petroferm BioactVS-0 Precision Cleaner, and thermally cured by heating overnight at 37 degrees Celsius.

184 Polydimethylsiloxane (PDMS) elastomer from Sylgard Dow-Coming was mixed in a Keyence Hybrid Mixer HM501 to form the fluidic channels. A first layer of PDMS was cured first with degassing in a vacuum chamber for 10 minutes and then at 80 degrees Celsius. A second thinner layer of PDMS was then applied to the first layer and the wax molds were then placed upon this uncured second layer. Finally, a third PDMS layer was applied to the wax mold. The three layer block was then dried under vacuum and heated at 54 degrees Celsius for four hours. The PDMS blocks were then cropped and de-waxed using heat (90 degrees Celsius) and acetone.

### EXAMPLE 2

### Assembly of Y-Junction Evaporative Cooling Apparatus

The resulting PDMS Y-junction was then attached to a refrigerant through one arm channel and to nitrogen gas inlets through the second arm channel. An Omega Precision fine wire, k-type thermocoupler was inserted into the outlet of the fluidic channel. This thermocoupler has a diameter of 0.125 mm, thus it is small enough that it does not interfere with the outlet of refrigerant or gas. The thermocoupler was attached to an Omega iSeries i/32 temperature controller to measure and log the temperature at a rate of approximately three times per second. Temperature measurements were made using the controller interfaced with a computer via a serial port and Microsoft HyperTerminal. The inlet pressures of the refrigerant and the gas were monitored by digital pressure meters (TIF Instruments).

### Example 3

### FIG. 2

As shown in FIG. 2, the lowest refrigeration temperature amongst four refrigerants (diethylether, isopropanol, acetone and ethanol) was obtained using diethyl ether, when the nitrogen gas was applied at 21 psi and the angle between the two arm channels was 10 degrees.

### EXAMPLE 4

### FIG. 3

As shown in FIG. 3, nitrogen gas applied at a pressure of 21 psi was the lowest pressure required to obtain the lowest refrigeration temperature with the angle between the two arm channels at 10 degrees and the refrigerant being diethyl ether. Specifically in FIG. 3, the top data line represents 12 psi; the middle data line starting at time=0 minutes at −12.5 degrees represents 15 psi, and the bottom most data lines at the lowest temperature represent 21 and 24 psi.

### EXAMPLE 5

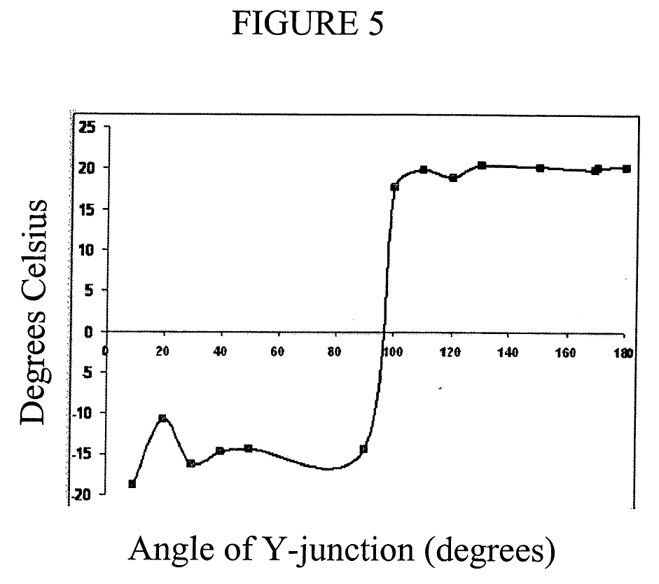

### FIGS. 4 and 5

As shown in FIGS. 4 and 5, an angle of 10 degrees between the two arm channels is the preferred arm angle for obtaining the lowest refrigeration temperature when the refrigerant is diethyl ether and the nitrogen gas is applied at 21 psi.

### EXAMPLE 6

### Integration of Apparatus into Semiconductor Devices

The Y-junction cooler apparatus of the present disclosure can be etched into semiconductor devices. Through photolithographic and acid etch processes, channels can be fabricated into dielectric and via layers of a semiconductor. Furthermore, channels can be etched into the top or back-side of a wafer, or into an insulator layer (e.g. silicon on insulater (SOI) chipsets).

While illustrative embodiments have been shown and described in the above description, numerous variations and alternative embodiments will occur to those skilled in the art. Such variations and alternative embodiments are contemplated, and can be made without departing from the scope of the invention as defined in the appended claims.

1. An apparatus for evaporative cooling comprising:
a Y-junction comprising a first input channel, a second input channel, a junction region and an output channel, wherein refrigerant is fed through the first input channel and gas is fed through the second input channel; said refrigerant and gas mixing at said junction region.

2. The apparatus of claim 1 wherein the Y-junction is made of polydimethylsiloxane.

3. The apparatus of claim 1 wherein the first and second input channels each have a length of 6.5 mm and a diameter of 0.650 mm.

4. The apparatus of claim 1 wherein the first input channel and the second input channel are positioned at an angle between 10 and 180 degrees to each other.

5. The apparatus of claim 1 wherein the refrigerant is selected from the group consisting of diethyl ether, isopropanol, acetone and ethanol.

6. The apparatus of claim 1 wherein the refrigerant is diethyl ether.

7. The apparatus of claim 1 wherein the first input channel and the second input channel are positioned at an angle of 10 degrees to each other.

8. The apparatus of claim 1 further comprising a thermocoupler, said thermocoupler positioned in said output channel.

9. The apparatus of claim 1 wherein the gas is nitrogen.

10. The apparatus of claim 1 wherein the second input channel contains gas at a pressure between 0 and 36 pounds per square inch (psi).

11. The apparatus of claim 1 wherein the second input channel contains gas at a pressure of 21 psi.

12. The apparatus of claim 1 wherein said apparatus provides cooling to at least −20 degrees Celsius.

13. The apparatus of claim 1 wherein said apparatus provides cooling rates at about 40 degrees Celsius per second.

14. The apparatus of claim 1 wherein said apparatus is etched into a semiconductor device.

15. The apparatus of claim 14, wherein said apparatus is etched by a photolithographic or acid etch process.

16. A method for fabricating an apparatus for evaporative cooling comprising
forming a mold of a Y junction comprising a first and a second input channel, a junction region and an output channel;
chemically curing the wax mold;
thermally curing the wax mold;
preparing polydimethylsiloxane
applying the polydimethylsiloxane to the wax mold to form a polydimethylsiloxane block;
cropping the polydimethylsiloxane block;
de-waxing the polydimethylsiloxane block by heat;
rinsing the polydimethylsiloxane blocks to remove residual wax;
providing refrigerant to the first input channel, and
providing gas to the second input channel.

17. The method for fabricating an apparatus for evaporative cooling of claim 16, further comprising: inserting a thermocoupler into the output channel.

18. The method of claim 17 further comprising the step of inserting a selective membrane in the output channel.

19. The method of claim 18 wherein the selective membrane is polydimethylsiloxane.

20. A method for providing localized evaporative cooling to a system, comprising:
attaching a Y-junction device to said system wherein the Y-junction device comprises a first and a second input channel, a junction region and an output channel; feeding refrigerant through the first input channel; feeding gas through the second input channel, whereby the refrigerant and gas mix at the junction.

21. The method of claim 20 wherein the first and second input channels are each 6.5 mm in length and have a diameter of 0.650 mm.

22. The method of claim 20 wherein the refrigerant is selected from the group consisting of diethyl ether, isopropanol, acetone and ethanol.

23. The method of claim 20 wherein the gas is nitrogen.

24. The method of claim 20 wherein the first input channel and the second input channel are positioned at an angle of 10 degrees to each other.

25. The method of claim 20 further comprising the step of inserting a thermocoupler into the output channel.

26. The method of claim 25 further comprising the step of attaching a thermometer to the thermocoupler.

27. The method of claim 26 further comprising the step of measuring the temperature by means of the thermocoupler and thermometer.

28. The method of claim 20 wherein the Y-junction device is fabricated from polydimethylsiloxane.

29. The method of claim 20 further comprising inserting a selective membrane into the output channel.

30. The method of claim 29 wherein the selective membrane is polydimethylsiloxane.

31. The method of claim 29 further comprising conserving the refrigerant by retention of said refrigerant by the selective membrane.

32. The method of claim 20 further comprising the step of attaching the Y-junction device to silicon.

33. A method of using the apparatus of claim 1, further comprising: connecting the apparatus to a microfluidic device.

34. The method of claim 33, wherein a cooling temperature of −20 degrees Celsius is sustained within the microfluidic device.

35. The method of claim 33, wherein the rate of cooling is 40 degrees Celsius per second.

36. The method of claim 20 further comprising the step of etching the apparatus into a semiconductor.

37. The method of claim 36 wherein the etching is a photolithographic or an acid etch process.
